(19) United States
(12) Patent Application Publication
(10) Pub. No.: US 2008/0197731 A1
(43) Pub. Date: Aug. 21, 2008

(54) Brushless motor and pump mounted with brushless motor

(75) Inventor: Hideki Kusano, Minami-ku (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NIDEC CORPORATION, Kyoto (JP)

(21) Appl. No.: 11/706,286

(22) Filed: Feb. 15, 2007

(51) Int. Cl. H02K 1/00; H02K 5/12; H02K 5/00; H02K 21/12; F04B 17/00

(52) U.S. Cl. 310/86; 310/87; 310/89; 417/423.3; 310/156.06

(57) ABSTRACT

A bottom portion side rib and a flange portion side rib are respectively formed on the bottom portion and the flange portion of the inner cover. The bottom portion side rib includes a plurality of bottom portion side radial ribs and a plurality of bottom portion side circular ring shaped ribs connecting the plurality of bottom portion side radial ribs. The flange portion side rib includes a plurality of flange portion side radial ribs and a flange portion side circular ring shaped rib connecting the plurality of flange portion side radial ribs.

### BACKGROUND OF THE INVENTION

1. Technical Fields

The present invention relates to a brushless motor in which an armature is sealed by an inner cover and an outer cover, and a pump mounted with the brushless motor.

2. Background of the Related Art

In the brushless motor (hereinafter referred to simply as motor) mounted on a water pump (hereinafter referred to simply as pump), a configuration in which a space for sealing the armature and the like is formed by combining a plurality of cylindrical covers to isolate the armature from the external liquid is conventionally known.

The configuration of the conventional pump will now be described with reference to FIG. 6. FIG. 6 is a frame format cross sectional view taken along the axial direction showing the conventional pump.

With reference to FIG. 6, a pump 1 is configured by a rotating body 2 including an impeller 2a and a rotor magnet 2b rotating with a predetermined center axis J1 as the center, a shaft 3a coaxially arranged with the center axis J1, an inner cover 3b of bottomed cylindrical shape for accommodating the rotating body 2, an armature 3c arranged on the outer peripheral surface of the inner cover 3b, an outer cover 3d for covering the outer surface of the armature 3c, and a lid member 3e for fixing the shaft 3a and covering the inner cover 3b. A pass through hole 3b1 is formed in the inner cover 3b at a position concentric with the center axis J1. A region 3e1 for fixing the shaft 3a of the lid member 3e is inserted and fixed at the pass through hole 3b1. Liquid (e.g., water) is filled into a concave part 3b4 formed by the inner peripheral surface of a cylindrical portion 3b2 and a bottom portion 3b3 of the inner cover 3b.

However, the inner cover 3b is combined with the lid member 3e at the bottom portion 3b3 where water pressure is applied the most inside a can. The strength of the bottom portion 3b3 of the inner cover 3b is thus enhanced. Furthermore, a Hall element 4 is arranged in the pump 1 so as to be adjacent to the bottom portion 3b3. The rotation control of the rotating body 2 is performed as the Hall element 4 detects the position of a magnetic pole of the rotor magnet 2b. Thus, the gap between the Hall element 4 and the rotor magnet 2b must be narrowed, and the lid member 3e is not arranged at the bottom portion 3b3 of the inner cover 3b at the portion where the Hall element 4 is arranged. As a result, the strength of the bottom portion 3b3 may be lowered at the portion of the bottom portion 3b3 where the Hall element 4 is arranged.

Therefore, the conventional configuration has the following problems.

1) The number of components increases by using the lid member 3e, which is a separate member, for reinforcement of the inner cover 3b, and thus the unit cost of the pump increases.

2) The bottom portion 3b3 may not be able to withstand the water pressure since the strength of the bottom portion 3b3 of the inner cover 3b at the portion where the Hall element 4 is arranged is low. As a result, water may leak to the armature 3c, thereby causing electrical short circuit.

3) The thickness of the cylindrical portion 3b2 of the inner cove 3b is made as thin as possible to have the gap in the radial direction between the armature 3c and the rotating body 3 as small as possible. As a result, the strength at the cylindrical portion 3b2 of the inner cover 3b may be lowered.

### BRIEF SUMMARY OF THE INVENTION

The brushless motor of the present invention can enhance the strength of the inner cover by arranging a plurality of radial ribs extending in the radial direction and arranged radially and a circumferential rib forming a circular ring shape or a circular arc shape with the center axis as the center on the inner cover including a cylindrical portion and a bottom portion having the center axis coaxial with the rotation axis as the center. The plurality of radial ribs and the circumferential rib are connected. The circumferential rib is formed in pluralities concentrically with the center axis as the center.

The brushless motor of the present invention is formed with a flange portion extending to the outer side in the radial direction at the portion on the lower side along the rotation axis of the cylindrical portion of the inner cover. A plurality of radial ribs of the flange portion extending in the radial direction and arranged radially and a circumferential rib of the flange portion for connecting the plurality of radial ribs of the flange portion are formed on the flange portion. A plurality of axial ribs is formed on the cylindrical portion of the inner cover to connect the plurality of radial ribs of the bottom portion and the radial ribs of the flange portion.

The strength of the bottom portion can be enhanced by forming the plurality of radial ribs and the plurality of circumferential ribs connecting the plurality of radial ribs on the bottom portion of the inner cover. In addition, the strength of the flange portion can be enhanced by forming the plurality of radial ribs of the flange portion and the circumferential rib of the flange portion on the flange portion. Furthermore, the strength of the cylindrical portion can be enhanced by forming the axial rib on the cylindrical portion.

### BRIEF DESCRIPTION OF THE SEVERAL VIEWS OF THE DRAWINGS

FIG. 1 is a frame format cross sectional view taken along an axial direction showing one aspect of an embodiment of a brushless motor of the present invention;

FIG. 2 is a frame format cross sectional view taken along the axial direction showing one aspect of an inner cover of the present invention;

FIG. 3 is a plan view seen from the upper side showing one aspect of the inner cover of the present invention;

FIG. 4 is a plan view seen from the upper side showing one aspect of the inner cover and an armature of the present invention;

FIG. 5 is a frame format cross sectional view taken along the axial direction showing one aspect of an embodiment of a pump of the present invention; and

FIG. 6 is a frame format cross sectional view taken along the axial direction showing one aspect of an embodiment of a conventional pump.

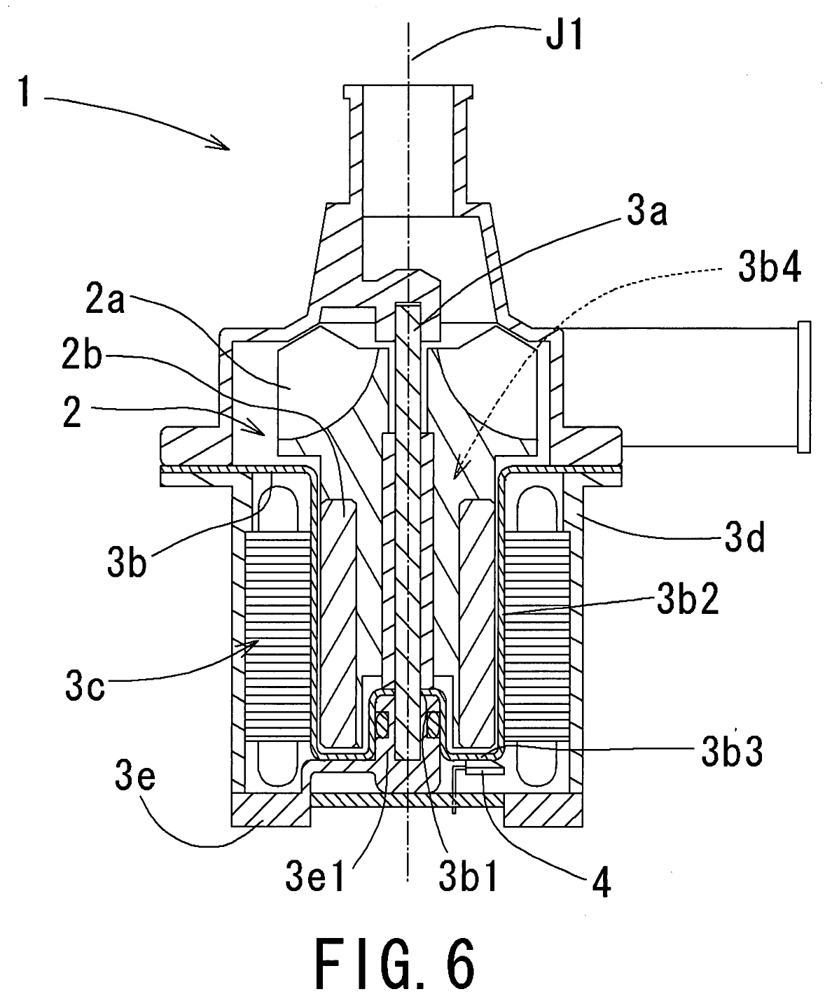

### DETAILED DESCRIPTION OF THE INVENTION

### <Entire Configuration of Brushless Motor>

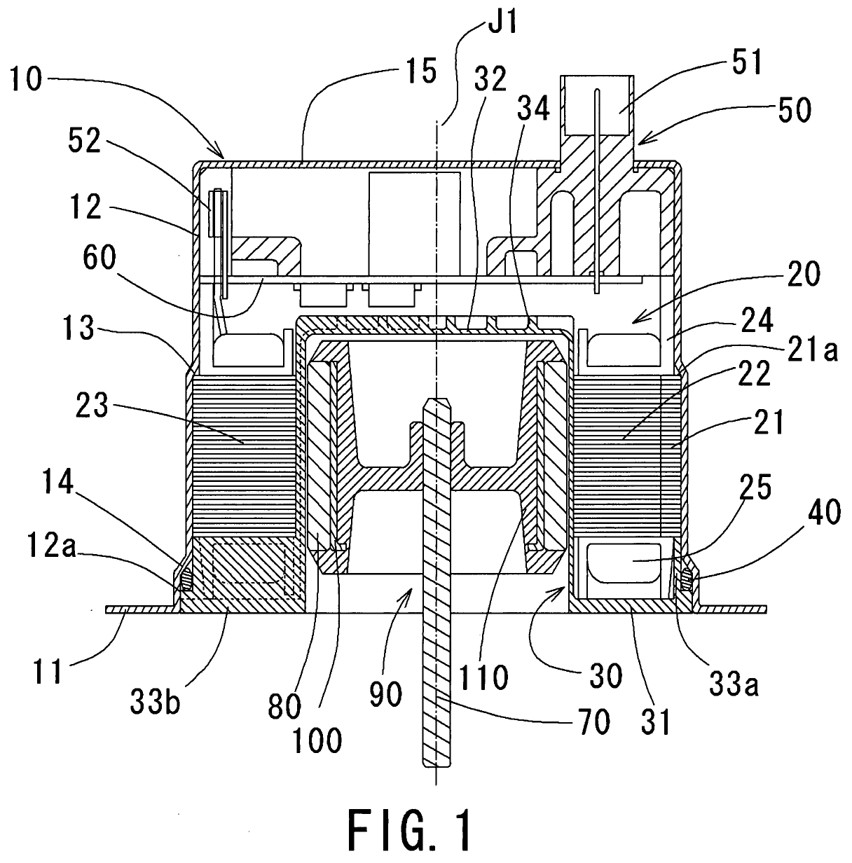

One aspect of an embodiment of a motor according to the present invention will now be described with reference to FIG. 1. FIG. 1 is a frame format cross sectional view of the motor taken along the axial direction. With regards to the terms upper side and the lower side herein, the bottom portion side of the inner cover is considered the upper side and the opening side is considered the lower side with respect to the center axis J1. The upper side and the lower side described herein does not necessary match the direction of gravitational force. The center axis J1 is arranged so as to be coaxial with the rotation axis, which is the center of rotation of the rotating body 90.

With reference to FIG. 1, an outer cover 10 of bottomed cylindrical shape having a predetermined center axis J1 as the center is formed by plastic forming such as press working the steel plate. The outer cover 10 is opened on the lower side in the direction (hereinafter referred to simply as axial direction) along the center axis J1. An extending part 11 extending in a direction (hereinafter referred to simply as radial direction) perpendicular to the center axis J1 is integrally formed at the lower part of a cylindrical portion 12 of the outer cover 10. An upper side step portion 13 and a lower side step portion 14 spaced apart from each other in the axial direction are respectively formed at the cylindrical portion 12 of the outer cover 10. The upper side step portion 13 is formed at the center part in the axial direction of the cylindrical portion 12 of the outer cover 10 and positions an armature 20 to be hereinafter described in the axial direction. The lower side step portion 14 is formed on the lower side from the upper side step portion 13 of the outer cover 10, which lower side step portion 14 and an inner cover 30 to be hereinafter described position and hold a sealing member 40 to be hereinafter described in the axial direction and in the radial direction.

The armature 20 held at the upper side step portion 13 in the cylindrical portion 12 of the outer cover 10 includes an armature core 23 having a core back portion 21 formed into a circular ring shape and a plurality of tooth portions 22 (nine in the embodiment) extending radially inward; a plurality of insulators 24 (18 in embodiment) for fixing the armature core 23 from the upper side and the lower side in the axial direction; and a coil 25 formed by winding a conductive line by way of the insulator 24 at the tooth portion 22. A non-covered part 21a that is not covered by the insulator 24 is arranged at the outer peripheral edge of the core back portion 21, and the armature 20 is positioned in the axial direction by contacting the non-covered part 21a and the upper side step portion 13 of the outer cover 10.

The inner cover 30 is formed into a substantially bottomed cylindrical shape opened on the lower side in the axial direction. The construction material of the inner cover 30 is resin material having non-conductive property and non-magnetic property. The inner cover 30 is formed through injection molding and the like. A flange portion 31 extending to the outer side in the radial direction is formed at the lower part of a cylindrical portion 35 of the inner cover 30. The flange portion 31 contacts in the radial direction the lower side cylindrical portion 12a formed on the lower side from the lower side step portion 14 of the outer cover 10. A sealing member 40 is fixedly arranged between the flange portion 31 and the lower side step portion 14 of the outer cover 10.

A substantially circular ring shaped bus bar 50 is arranged at the upper part of the cylindrical portion 12 of the outer cover 10 so as to contact the inner peripheral surface of the cylindrical portion 12 and the lower surface of the bottom portion 15. An opening is formed at the bottom portion 15 of the outer cover 10, and a connector 51 supplied with current from the external power supply is arranged on the inner side of the opening. The connector 51 is integrally molded with the bus bar 50. The bus bar 50 includes a plurality of terminals 52 wire connecting the coil 25 of the armature 20. A circuit substrate 60 for performing rotation control by controlling the current flow timing to the armature 20 is fixed at the lower surface of the bus bar 50. The terminal 52 is electrically connected to the connector 51 by way of the circuit substrate 60.

A rotating body 90 including a columnar shaft 70 formed along the center axis J1 and a rotor magnet 80 arranged with a gap in the radial direction with the armature 20 is formed on the inner side in the radial direction of the inner cover 30. The rotating body 90 further includes a yoke 100 of a magnetic body arranged contacting the inner side in the radial direction of the rotor magnet 80, and a holding member 110 for fixedly holding the shaft 70, the rotor magnet 80 and the yoke 100. The holding member 110 is injection molded from resin material and is formed into a substantially H shape.

The motor is supplied with current from the external power supply (not shown) at appropriate current flow timing to the armature 20, whereby magnetic field is generated at the armature 20. The rotating body 90 rotates by the interaction of the magnetic field and the rotor magnet 80.

### <Main Part>

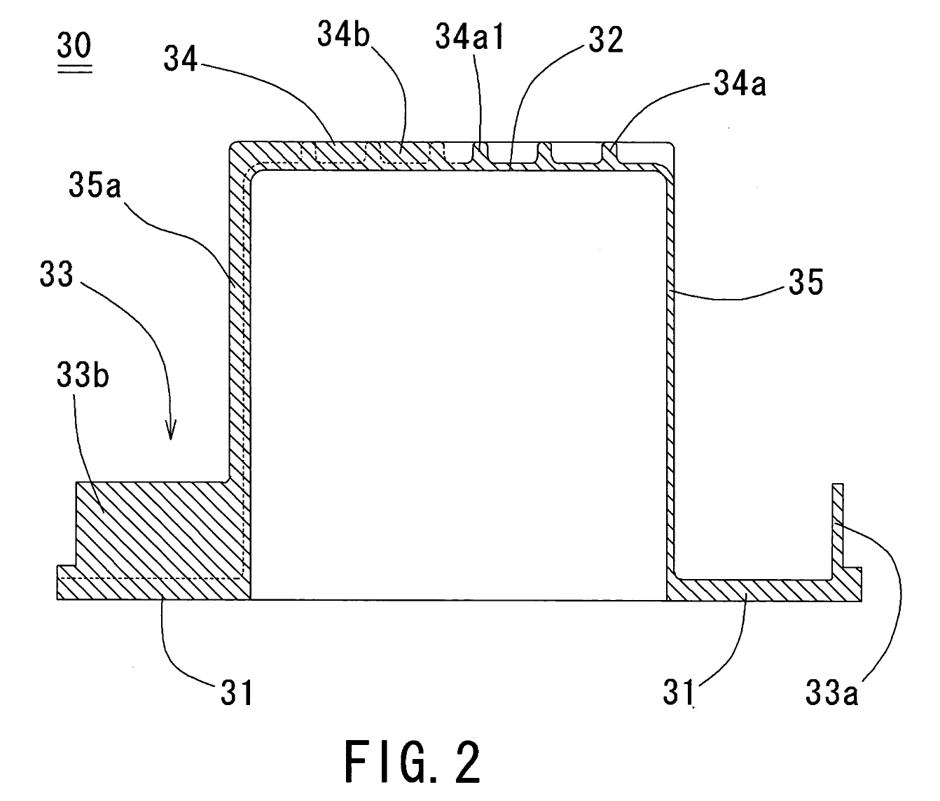

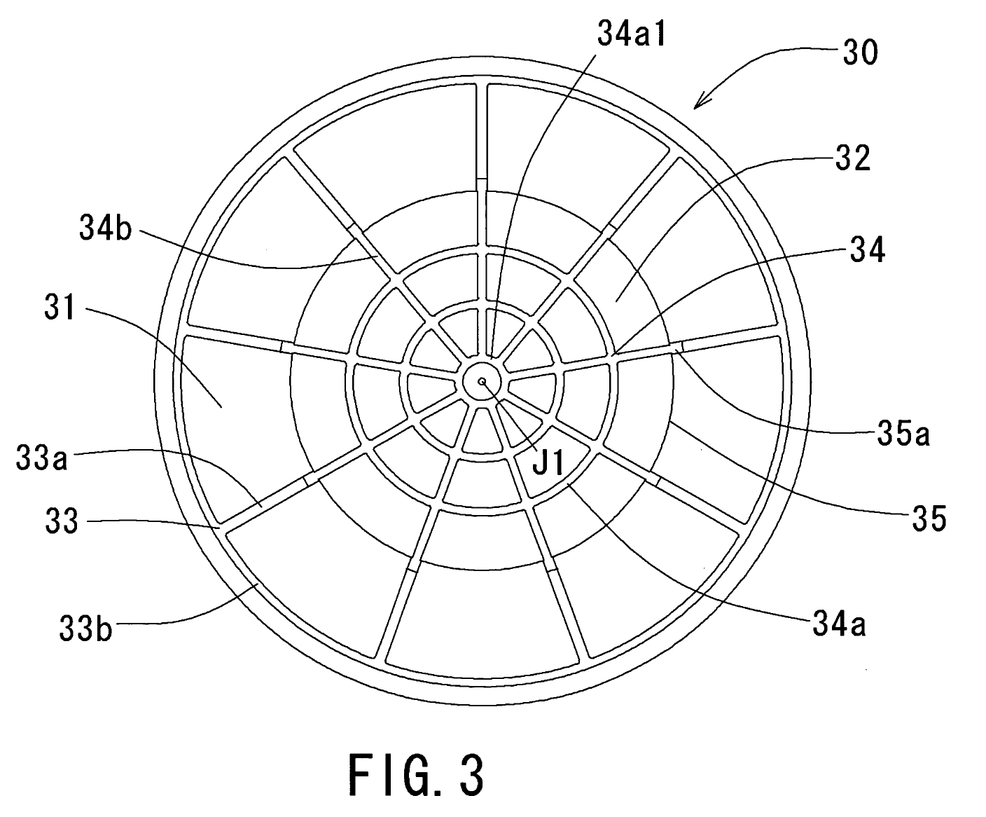

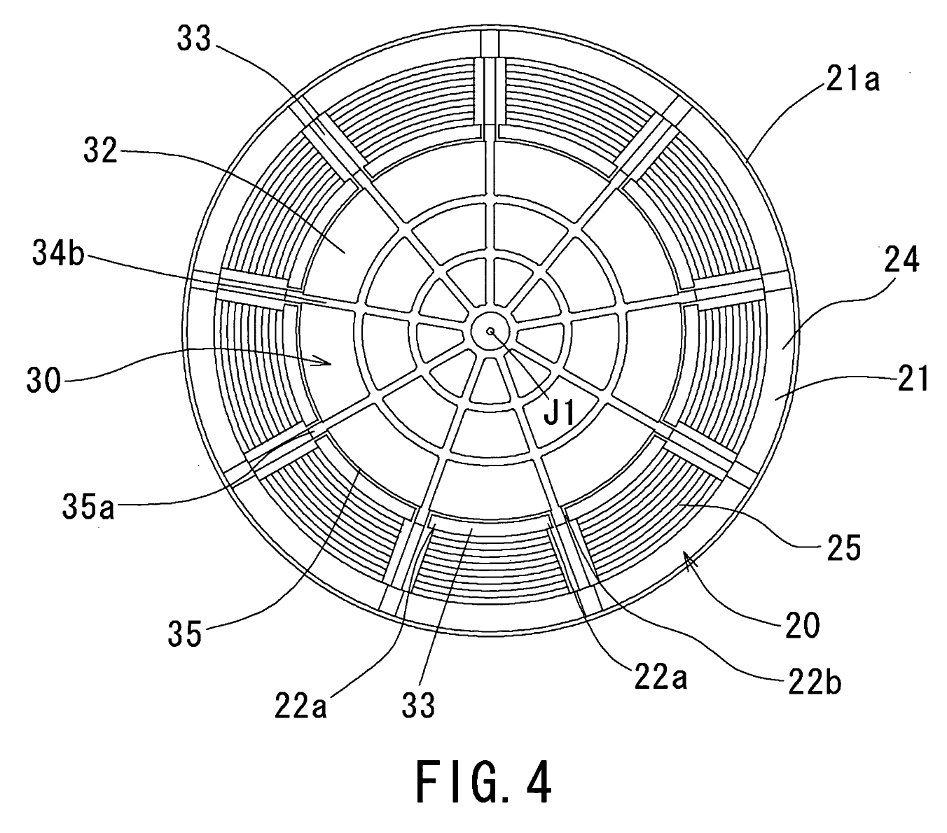

The shape of one aspect of an embodiment of the inner cover 30, which is a main part of the present invention, will now be described in detail with reference to FIGS. 1 to 4. FIG. 2 is a frame format cross sectional view taken along the axial direction of the inner cover 30. FIG. 3 is a plan view of the inner cover 30 seen from the upper side. FIG. 4 is a plan view seen from the upper side of when the armature 20 and the inner cover 30 are combined.

With reference to FIG. 2, the inner cover 30 formed into a substantially cylindrical shape is formed so that the thickness in the radial direction of the position in the circumferential direction at the cylindrical portion 35 of the inner cover 30 facing the tooth portion 22 of the armature 20 becomes the thinnest. The gap in the radial direction between the armature 20 and the rotor magnet 80 can be thereby reduced. Therefore, the magnetic loss caused by the gap can be reduced. As a result, the motor of magnetically high efficiency can be obtained. A flange side rib 33 and a bottom portion side rib 34 are respectively formed at the flange portion 31 and the bottom portion 32 of the inner cover 30.

The flange portion side rib 33 and the bottom portion side rib 34 will now be described with reference to FIG. 3.

The flange side rib 33 has a plurality of radial ribs 33b (9 in the embodiment) formed so as to extend to the outer side in the radial direction from the cylindrical portion 35 of the cylindrical portion 30. A circumferential rib 33a of a circular ring shape formed on the outer side in the radial direction of the flange portion 31 is integrally formed with the flange portion 31 and the radial rib 33b. In other words, the radial ribs 33b are connected in the circumferential direction by the circumferential rib 33a. The strength of the flange portion 31 can be thereby enhanced. The strength of the radial rib 33b itself can be also enhanced since the radial rib 33b is integrally formed from the cylindrical portion 35. The strength of the radial rib 33b can be further enhanced by being integrally formed with the circumferential rib 33a. With regard to the circumferential rib 33a, the strength of the circumferential rib 33a itself can be enhanced by being integrally formed with the radial rib 33b.

With reference to FIG. 1, the radial rib 33b and the circumferential rib 33a contact the lower surface of the armature 20 to position the inner cover 30 in the axial direction. The armature 20 is thereby sandwiched in the axial direction when the upper surface of the core back portion 21 contacts the upper side step portion 13 of the outer cover 10, and the lower surface of the core back portion 21 contacts the radial ribs 33b and the circumferential rib 33a. The armature 20 is thereby strongly held in the axial direction. Consequently, the vibration produced by the armature 20 when the motor rotates can be greatly reduced. Moreover, the height in the axial direction of the brushless motor can be reduced since the coil 25 and the radial rib 33b can be overlapped in the axial direction by forming the radial rib 33b between each coil 25 of the armature 20.

Again with reference to FIG. 3, the bottom portion side rib 34 formed on the bottom portion 32 of the inner cover 30 includes a plurality of circumferential ribs 34a (three in the embodiment) formed concentric and into a circular ring shape with respect to the center axis J1, and a plurality of radial ribs 34b (nine in the embodiment) formed radially extending in the radial direction. The circumferential rib 34a and the radial rib 34b are integrally formed with the bottom portion 32. The circumferential ribs 34a each connects the plurality of radial ribs 34b in the circumferential direction. Therefore, the strength of the plurality of circumferential ribs 34a and the plurality of radial ribs 34b can be respectively enhanced. Furthermore, the end in the radial direction of the radial rib 34b is integrally formed with the inner side circumferential rib 34a1 formed on the inner most side in the radial direction (i.e., closest to center axis J1) at the circumferential rib 34a. The strength of each radial rib 34b can be thereby enhanced. Compared to the bottom portion configured in a plane as in the prior art, the vibration energy radiated from the bottom portion 32 can be more dispersed with the bottom portion 32 having a configuration in which the plurality of circumferential ribs 34a and the radial ribs 34b are integrally combined as in FIG. 3. The vibration of the inner cover 30 can be thereby reduced.

The strength may be also enhanced by thickening the thickness in the axial direction of the flange portion 31 and the bottom portion 32 instead of the flange portion side rib 33 and the bottom portion side rib 34. However, problems of pores and cracks may arise if the thickness in the axial direction of the flange portion 31 and the bottom portion 32 is thickened in the process of injection molding the resin material. The dimension accuracy of the inner cover 30 may lower and the strength of the inner cover 30 may lower as a result. Therefore, it is effective to form the flange portion side rib 33 and the bottom portion side rib 34 that can be injection molded from the resin material with approximately the same thickness of the inner cover 30.

The lid member, which is a separate member in the prior art, does not need to be attached to the inner cover 30 in order to enhance the strength of the inner cover 30 by forming the flange portion side rib 33 and the bottom portion side rib 34. Therefore, the number of components configuring the pump can be reduced. Furthermore, a part for positioning and fixing the lid member must be formed when using the lid member, which is a separate member. Therefore, the inner configuration of the motor becomes complicating. However, since this is responded only by forming the flange portion side rib 33 and the bottom portion side rib 34 in the present invention, other components are not affected at all. Therefore, the inner configuration of the motor can be simplified.

With reference to FIG. 3, the thickness in the circumferential direction of the plurality of radial ribs 33b at the flange portion 31 is formed thicker than the thickness in the circumferential direction of the plurality of radial ribs 34b at the bottom portion 32. With reference to FIG. 1, the size of the width in the axial direction from the upper surface of the flange portion 31 of the plurality of radial ribs 33b at the flange portion 31 is greater than the size of the width in the axial direction from the upper surface of the bottom portion 32 of the plurality of radial ribs 34b at the bottom portion 32.

The outer peripheral surface of the circumferential rib 33a of the flange portion 31 is arranged with a gap between the inner peripheral surface of the lower side cylindrical portion 12a of the outer cover 10 facing in the radial direction. A sealing member 40 for sealing the gap by being contacted to the outer peripheral surface of the circumferential rib 33a and the inner peripheral surface of the lower side cylindrical portion 12a is arranged in the gap. The outer peripheral surface of the circumferential rib 33a and the inner peripheral surface of the cylindrical portion 12 on the upper side of the lower side step portion 14 contact at the upper side in the axial direction of the sealing member 40. Therefore, the space defined by the inner cover 30 and the outer cover 10 can be sealed. Furthermore, the outer peripheral surface of the flange portion 31 and the inner peripheral surface of the lower side cylindrical portion 12a contact at the lower side in the axial direction of the sealing member 40. Therefore, the space defined by the inner cover 30 and the outer cover 10 can be sealed. The sealing structure using the sealing member 40 can achieve a more satisfactory sealing structure the greater the width in the axial direction from the upper surface of the flange portion 31 of the circumferential rib 33a. The strength of the circumferential rib 33a itself becomes weak the greater the width in the axial direction from the upper surface of the flange portion 31 of the circumferential rib 33a. However, the strength of the circumferential rib 33a can be enhanced since a plurality of radial ribs 34b are connected to and integrally molded with the circumferential rib 33a. Furthermore, the thickness in the circumferential direction becomes thinner towards the upper side in the axial direction as a draft angle is formed when die releasing the die (not shown) in forming the plurality of radial ribs 34b. However, the thickness in the circumferential direction at the upper side in the axial direction of the radial rib 33b can be ensured even if the width in the axial direction from the upper surface of the flange portion 31 of the radial rib 33b is formed large by thickening the thickness in the circumferential direction of the portion to be connected to the flange portion 31 of the radial rib 33b. Therefore, the strength of the radial rib 33b itself can be enhanced. Furthermore, the strength of the circumferential rib 33a can be enhanced since the circumferential rib 33a is connected to the radial rib 33b with the strength of the radial rib 33b itself enhanced.

With reference to FIG. 4, a circumferential extending part 22a extending in the circumferential direction is formed at both ends in the circumferential direction of the distal end on the inner peripheral side of the plurality of tooth portion 22 (i.e., region closest to the center axis J1 in tooth portion 22) of the armature 20. The circumferential extending parts 22a are arranged in the circumferential direction by way of a gap 22b.

A plurality of axial ribs 35a (nine in the embodiment) widening in the axial direction of the cylindrical portion 35 is formed so as to extend radially outward at the portion facing in the radial direction the gap 22b of the cylindrical portion 35 of the inner cover 30. As a result, the axial rib 35a is in a state inserted into the gap 22b.

Generally, the magnetic efficiency enhances as the gap in the radial direction between the armature 20 and the rotor magnet 80 becomes narrower. Therefore, the gap in the radial direction is desirably made as narrow as possible. However, if such gap in the radial direction is made narrow, the thickness in the radial direction of the cylindrical portion 35 of the inner cover 30 arranged in the gap in the radial direction must be molded to the thinnest thickness within a moldable range. The flow of resin material thereby worsens when molding the cylindrical portion 35. This may become the cause of defective molding of the inner cover 30.

However, according to the formation of the plurality of axial ribs 35a, the path for flowing the resin material can be enlarged due to the axial rib 35a even if the cylindrical portion 35 is formed to the thinnest thickness within the moldable range. Therefore, the flow of the resin material is improved by the axial rib 35a, and the moldability of the resin material can be enhanced. The inner cover 30 is stably manufactured as a result. Furthermore, the plurality of axial ribs 35a are connected to and integrally molded with the plurality of radial ribs 34b formed at the bottom portion 32 of the inner cover 30. Therefore, the flow of the resin material is further improved when molding the inner cover 30 with the resin material. Consequently, the moldability of the inner cover 30 can be further enhanced. The plurality of axial ribs 35a are also connected to and integrally molded with the plurality of radial ribs 33b. As a result, the moldability of the inner cover 30 can be further enhanced. The strength of the inner cover 30 can be enhanced by connecting and integrally molding the axial ribs 35a, the radial ribs 34b of the bottom portion 32, and the radial ribs 33b of the flange portion 31.

With reference to FIG. 1, the method of driving the brushless motor of the present embodiment is a sensorless type in which a position detecting electronic component such as Hall element is not used. In particular, the sensorless type of the present invention is a method of acquiring and using the positional information from a reverse electromotive force waveform generated at the coil 25. Thus, the gap in the axial direction between the rotor magnet and the circuit substrate mounted with position detecting electronic components needed to be reduced in order to enhance the positional detecting accuracy when using the position detecting electronic component such as Hall element of the prior art. The thickness of the bottom portion of the inner cover arranged in the axial direction between the positional detecting electronic component and the rotor magnet therefore needed to be formed thin. However, the position detecting electronic component is not necessary and the thickness of the bottom portion 32 of the inner cover 30 can be freely set by employing the sensorless drive for the driving method as in the present invention. Therefore, the sensorless type is suitable in forming the bottom portion side rib 34 at the bottom portion 32.

### <Pump>

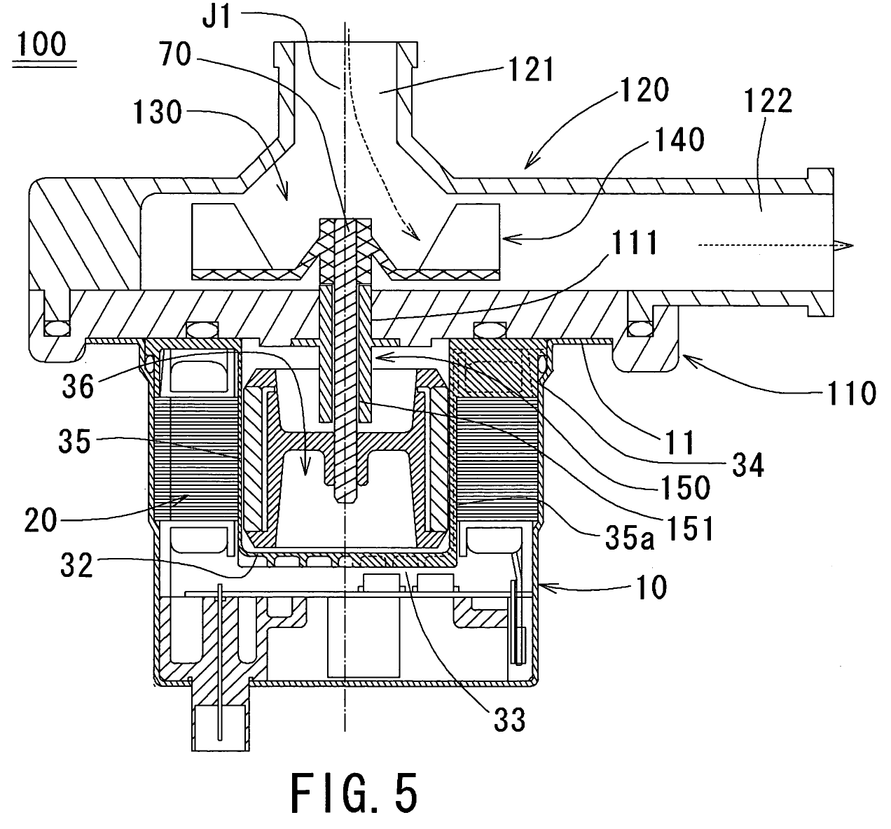

One aspect of the embodiment of the pump 100 of the present invention will now be described with reference to FIG. 5. FIG. 5 is a frame format cross sectional view taken along the axial direction of the pump 100 of the present invention.

The pump 100 includes a first pump casing 110 contacting the lower surface in the axial direction of the extending part 11 of the outer cover 10, and a second pump case 120 contacting the first pump case 110 thereby forming a pump chamber 130. An impeller 140 fixed with the shaft 70 and integrally rotated with the rotating body 90 is arranged in the pump chamber 130.

An opening 111 that passes along the center axis J1 is formed in the first pump case 110. The shaft 70 is inserted inside the opening 111. A sleeve 150 that supports the shaft 70 in a freely rotatable manner in the radial direction is fixed to the internal surface of the opening 111. The sleeve 150 is molded by resin material. The sleeve 150 is formed into a substantially cylindrical shape having an insertion hole 151 passing along the center axis J1, which is to be inserted with the shaft 70.

The second pump case 120 includes a flow-in part 121 for flowing in the liquid into the pump chamber 130, and a flow-out part 122 for flowing out the liquid in the pump chamber 130 to the outside. The flow-in part 121 is formed so as to extend in the direction along the center axis J1. The flow-out part 122 is formed so as to extend in the direction along the radial direction.

A spiral shape flow path (not shown) is formed in the pump chamber 130, and the flow-out part 122 is formed in the circumferential direction along such flow path. As the impeller 140 rotates, the liquid in the flow path flows along the flow path towards the rotating direction of the impeller 140.

A concave part 36 on the inner side of bottomed cylindrical shape of the inner cover 30 is filled with liquid. Therefore, pressure is applied to the bottom portion 32 and the cylindrical portion 35 of the inner cover 30 by the liquid. A great pressure is applied particularly to the bottom portion 32. However, the strength of the inner cover 30 is enhanced since the bottom portion side rib 34 and the axial rib 35a are respectively formed on the bottom portion 32 and the cylindrical portion 35 applied with pressure from the liquid in the present invention. Thus, the cracks can be prevented at the bottom portion 32 and the cylindrical portion 35 of the inner cover 30 even if pressure is applied to the concave part 36 by the liquid. Furthermore, the vibration generated when the flow of liquid impacts the concave part 36 of the inner cover 30 can be reduced since the strength of the inner cover 30 is high.

The motor and the pump of the present invention are desirably mounted on a vehicle. Product guarantee at higher temperature is demanded for the vehicle compared to household electronics in a general household. When the outer cover 10 is molded by resin material, in particular, a special resin material responding to high temperature becomes necessary, which considerably increases the material cost of the outer cover 10. However, the material cost can be suppressed to low cost while ensuring radiation performance of the armature 20 by press working the metal plate to form the outer cover 10. Consequently, the motor and the pump that can withstand an environment of high temperature such as vehicle can be provided at low cost.

One aspect of the embodiment of the present invention has been described, but the present invention is not limited to the above embodiment, and modifications are possible within the scope of the Claims.

For example, radial ribs 33b, 34b are formed in FIG. 3 of the embodiment, but the number of radial ribs 33b, 34b is not limited to the number in the figure, and the effect can be exhibited as long as at least one of each is formed.

A plurality of circumferential ribs 34a of the bottom portion 32 are formed in FIG. 3 of the embodiment, but the number of circumferential ribs 34a is not limited to the number in the figure, and the effect can be exhibited as long as at least one is formed.

Moreover, the circumferential rib 34a of the bottom portion 32 and the circumferential rib 33a of the flange portion 31 are formed into a circular arc shape in FIG. 3 of the embodiment, but is not limited thereto, and the shape of the circumferential ribs 33a, 34a may, for example, be a circular arc shape since the radial ribs 33b, 34b merely needs to be connected.

What is claimed is:

1. A brushless motor comprising:
a rotating body including therein a rotor magnet, and rotating around a rotation axis;
an inner cover surroundingly covering the rotating body in a radial direction, including therein a cylindrical portion concentric with the rotating body, a bottom portion for blocking an axially upper side of the cylindrical portion, wherein the inner cover is made of a non-conductive and non-magnetic resin material;
an outer cover surroundingly covering at least a portion of the inner cover in the radial direction, including therein a cylindrical portion having a diameter larger than that of the cylindrical portion of the inner cover and concentric with the rotation axis, and a bottom portion for blocking the axially upper side of the cylindrical portion; and
an armature, affixed to the outer cover, and arranged inside the cylindrical portion of the outer cover and outside the cylindrical portion of the inner cover, for generating a rotating magnetic field, wherein
the bottom portion of the inner cover includes on a top surface thereof in the axial direction a plurality of radial ribs each extending in the radial direction, and at least one circumferential rib having a ring shape or an arc shape centering around the center axis.

2. The brushless motor according to claim 1, wherein the at least one circumferential rib of the bottom portion of the inner cover each are arranged in a concentric manner about the center axis.

3. The brushless motor according to claim 1, wherein each radial rib on the bottom portion of the inner cover is connected to one another at an innermost portion thereof via the at least one circumferential rib.

4. The brushless motor according to claim 1, wherein
a flange portion whose area widens in the radial direction is provided at a lower portion in the axial direction of the cylindrical portion in the inner cover, and
a plurality of radial ribs each extending in the radial direction are arranged on the upper side of the flange portion.

5. The brushless motor according to claim 4, wherein
the armature includes,
a plurality of tooth portions having a predetermined distance therebetween in a circumferential direction, and each extending toward the rotation axis,
a core back portion for connecting an outmost portion of each tooth portion, and
a plurality of coils each formed by a conductive line wound around each tooth portion, wherein
the plurality of the radial ribs of the flange portion each are arranged in a gap between each coil.

6. The brushless motor according to claim 4, wherein each radial rib of the flange portion is designed to have a circumferential thickness greater than that of each radial rib of the bottom portion.

7. The brushless motor according to claim 4, wherein each radial rib of the flange portion is designed to have an axial thickness greater than that of each radial rib of the bottom portion.

8. The brushless motor according to claim 4, wherein
the flange portion has formed on the upper side thereof at least one circumferential rib each having the ring shape or the arc shape centering around the center axis,
each radial rib of the flange portion extends to the core back portion, and
a radially outmost portion of the radial rib of the flange portion is connected to the at least one circumferential rib of the flange portion.

9. The brushless motor according to claim 1, wherein the inner cover includes on an outer circumferential surface of the cylindrical portion a plurality of axial ribs each extending in the axial direction, the plurality of axial ribs each are arranged between each innermost portion of the tooth portions in the radial direction.

10. The brushless motor according to claim 9, wherein
a plurality of the axial ribs having a predetermined distance therebetween in the circumferential direction are provided on the circumferential surface of the cylindrical portion, and
each axial rib is connected to one of the plurality of the radial ribs on the bottom portion.

11. The brushless motor according to claim 9, wherein
a flange portion whose area widens in the radial direction is provided at a lower portion in the axial direction of the cylindrical portion in the inner cover,
a plurality of radial ribs each extending in the radial direction are arranged on the upper side of the flange portion, and
the plurality of axial ribs each are connected to one of the plurality of radial ribs.

12. The brushless motor according to claim 10, wherein
a flange portion whose area widens in the radial direction is provided at a lower portion in the axial direction of the cylindrical portion in the inner cover,
a plurality of radial ribs each extending in the radial direction are arranged on the upper side of the flange portion, and
the plurality of axial ribs each are connected to one of the plurality of radial ribs.

13. A brushless motor comprising:
a rotating body having therein a rotor magnet, and rotating around a rotation axis;
an inner cover surroundingly covering the rotating body in a radial direction, including therein a cylindrical portion concentric with the rotating body, a bottom portion for blocking an axially upper side of the cylindrical portion, wherein the inner cover is made of a non-conductive and non-magnetic resin material;
an outer cover surroundingly covering at least a portion of the inner cover in the radial direction, including therein a cylindrical portion having a diameter larger than that of the cylindrical portion of the inner cover and concentric with the rotation axis, and a bottom portion for blocking the axially upper side of the cylindrical portion; and
an armature, affixed to the outer cover, and arranged inside the cylindrical portion of the outer cover and outside the cylindrical portion of the inner cover, for generating a rotating magnetic field, wherein
a flange portion whose area widens in the radial direction is provided at a lower portion in the axial direction of the cylindrical portion in the inner cover, and
a plurality of radial ribs each extending in the radial direction are arranged on the upper side of the flange portion.

14. The brushless motor according to claim 13, wherein
the armature includes,
a plurality of tooth portions having a predetermined distance therebetween in a circumferential direction, and each extending toward the rotation axis,
a plurality of coils each formed by a conductive line wound around each tooth portion, wherein
the plurality of the radial ribs of the flange portion each are arranged in a gap between the plurality of coils.

15. The brushless motor according to claim 14, wherein
the flange portion has formed on the upper side thereof at least one circumferential rib each having the ring shape or the arc shape centering around the center axis,
each radial rib of the flange portion extends to the core back portion, and
a radially outmost portion of the radial rib of the flange portion is connected to the at least one circumferential rib of the flange portion.

16. The brushless motor according to claim 14, wherein each radial rib of the flange portion makes contact with a lower side in the axial direction of the core back portion.

17. The brushless motor according to claim 15, wherein the at least one circumferential rib of the flange portion makes contact with a lower side in the axial direction of the core back portion.

18. The brushless motor according to claim 16, wherein
a step portion for determining an axial position of the armature is formed at the cylinder portion of the outer cover, and
the armature is sandwiched by the step portion and the plurality of radial ribs of the flange portion.

19. The brushless motor according to claim 17, wherein
a step portion for determining an axial position of the armature is formed at the cylinder portion of the outer cover, and
the armature is sandwiched by the step portion and the at least one circumferential rib of the flange portion.

20. The brushless motor according to claim 15, wherein
a step portion for determining an axial position of the armature is provided on the cylinder portion of the outer cover,
the radial rib of the flange portion and the at least one circumferential rib of the flange portion make contact with the lower surface of the core back, and
the armature is sandwiched by the step portion and the plurality of radial ribs of the flange portion, and by the step portion and the at least one circumferential rib of the flange portion.

21. The brushless motor according to claim 8, wherein
the at least one circumferential rib of the flange portion each have a circular ring shape,
a sealing member is arranged in a gap between an outer circumferential surface of the at least one circumferential rib of the flange portion of the inner cover and an inner circumferential surface of the cylindrical portion of the outer cover, and
the at least one circumferential rib of the flange portion and the inner circumferential surface of the cylindrical portion of the outer cover make contact with one another at, at least, an axially upper portion of the sealing member.

22. The brushless motor according to claim 15, wherein
the at least one circumferential rib of the flange portion each have a circular ring shape,
a sealing member is arranged in a gap between an outer circumferential surface of the circumferential rib of the flange portion of the inner cover and an inner circumferential surface of the cylindrical portion of the outer cover, and
the circumferential rib of the flange portion and the inner circumferential surface of the cylindrical portion of the outer cover make contact with one another at, at least, an axially upper portion of the sealing member.

23. The brushless motor according to claim 1, wherein a circuit substrate having mounted thereon an electronic circuit component for supplying driving current to the armature in a sensorless method is arranged in a space between the bottom portion of the inner cover and the bottom portion of the outer cover.

24. A brushless motor comprising:
a rotating body having therein a rotor magnet, and rotating around a rotation axis;
an inner cover surroundingly covering the rotating body in a radial direction, including therein a cylindrical portion concentric with the rotating body, a bottom portion for blocking an axially upper side of the cylindrical portion, and, at a lower portion in the axial direction of the cylindrical portion, a flange portion whose area widens in the radial direction, wherein the inner cover is made of a non-conductive resin material and a non-magnetic material;
an outer cover surroundingly covering at least a portion of the inner cover in the radial direction, including therein a cylindrical portion having a diameter larger than that of the cylindrical portion located in the inner cover and concentric with the rotation axis, and a bottom portion for blocking the axially upper side of the cylindrical portion; and
an armature, affixed to the outer cover, and arranged inside the cylindrical portion of the outer cover and outside the cylindrical portion of the inner cover, for generating a rotating magnetic field, wherein
the bottom portion of the inner cover includes therein on a top surface thereof a plurality of radial ribs each extending in the radial direction, and at least one circumferential rib having a ring shape or an arc shape centering around the center axis,
a plurality of radial ribs each extending in the radial direction are formed on the top side of the flange portion, wherein the plurality of radial ribs on the top side of the flange portion and the plurality of radial ribs on the top surface of the bottom portion are correspondingly arranged with one another,
a plurality of axial ribs having a predetermined space therebetween are formed on the cylindrical portion of the inner cover, and
the plurality of axial ribs each are connected to one of the plurality of radial ribs on the bottom portion, and to one of the plurality of radial ribs on the flange portion.

25. A pump equipped with the brushless motor according to claim 1, the pump comprising:
a pump case including a pump chamber forming a flow path of liquid, a flow-in part for flowing in the liquid into the pump chamber, and a flow-out part for flowing out the liquid from the pump chamber, and connected to at least one of either the inner cover or the outer cover; and
an impeller arranged in the pump chamber, rotated with the rotating body and forming a flow path of the liquid.

26. A pump equipped with the brushless motor according to claim 13, the pump comprising:
a pump case including a pump chamber forming a flow path of liquid, a flow-in part for flowing in the liquid into the pump chamber, and a flow-out part for flowing out the liquid from the pump chamber, and connected to at least one of either the inner cover or the outer cover; and
an impeller arranged in the pump chamber, rotated with the rotating body and forming a flow path of the liquid.
